(19) United States
(12) Patent Application Publication
(10) Pub. No.: US 2016/0021984 A1
(43) Pub. Date: Jan. 28, 2016

(54) Multi-Function Buckle

(71) Applicant: Siya, Inc., Santa Fe Springs, CA (US)

(72) Inventor: Sudhir Mundhra, Cerritos, CA (US)

(73) Assignee: Siya, Inc.

(21) Appl. No.: 14/810,191

(22) Filed: Jul. 27, 2015

Related U.S. Application Data
(60) Provisional application No. 62/029,806, filed on Jul. 28, 2014.

(51) Int. Cl. A44B 11/00; F23Q 1/06; F21V 33/00; A44B 11/26; G10K 5/00

(52) U.S. Cl. CPC A44B 11/005; A44B 11/266; A44B 11/006; G10K 5/00; F21V 33/0004; F23Q 1/06

(57) ABSTRACT

A multi-function buckle having a noisemaker and a fire starter housed within the multifunction buckle so that the multifunction buckle can be used for a variety of purposes. The multifunction buckle may further have a light emitting device. The whistle can have two configuration, one in which the whistle is deployed for use, and one in which the whistle is stowed within the multi-function buckle, The fire starter may be a flint and a striker, one or both of which can be removed from the multi-function buckle so as to be scraped against one another to start a fire. The multi-function buckle may also have two end bars on opposite sides for attaching to a strap.

### CROSS-REFERENCE TO RELATED APPLICATION

This patent application claims the benefit of U.S. Provisional Patent Application Ser. No. 62/029,806, entitled “Multi-Function Buckle,” filed Jul. 28, 2014, which is incorporated in its entirety here by this reference.

### TECHNICAL FIELD

This invention is related to buckles that have multiple features that are useful when traversing the outdoors, such as hiking, camping, trekking, expeditions, military use, and other survival situations.

Outdoor enthusiasts are constantly battling with the amount of gear and equipment to carry and the level of preparation necessary to survive or enjoy the wilderness. The outdoor enthusiast can take a cautious approach and be very well prepared for almost any situation, but at the cost of carrying heavy gear. The minimalist may carry very few necessary tools, but experience great challenges.

Aside from how much gear to carry, the outdoorsmen has to determine where to carry the tools for the gear, such as in a backpack, on his belt, in his pocket, etc. The location for carrying tools in the gear may be determined by a number of factors, such as such probability of use, importance, ease of access, and the like. The more tools a person carries, the more the person has to consider where to carry the tool. The more tools the person carries in a single gear, the more difficult it becomes for retrieving the tool when needed.

Therefore, there is still a need for a device that facilitates carrying tools in an efficient manner that is secure and easily accessible.

### SUMMARY

The present invention is directed towards a buckle that performs a variety of functions by allowing certain tools to be carried on the buckle. For example, the buckle may carry a whistle, a striker, and a flint. In some embodiments, the buckle may carry a light emitting device. The buckle may have opposing ends that can be attached to a strap so that the buckle can be utilized as a belt or other fastening device. Like typical buckles, the present invention may have a connecting mechanism to connect one end of the buckle to a second end.

In another aspect of the present invention, the whistle can be inconspicuously hidden in the buckle by adopting a deployed configuration and a stowed configuration.

In another aspect of the present invention, the striker and flint may be removable from the buckle or useable without being removed from the buckle.

### BRIEF DESCRIPTION OF DRAWINGS

FIG. 1 is a perspective view of an embodiment of a Multi-Function Buckle, with the whistle segment connected to the clip segment.

FIG. 2 is a top view of the embodiment of the Multi-Function Buckle shown in FIG. 1, except that the whistle segment is disconnected from the clip segment.

FIG. 3 is a side view of the embodiment of the Multi-Function Buckle shown in FIG. 1, except that the whistle segment is disconnected from the clip segment. Additionally, the whistle is shown pivoted outward in the deployed configuration.

FIG. 4 is a perspective view of another embodiment of a multi-function buckle.

FIG. 5 is an exploded view of the multi-function buckle shown in FIG. 4.

FIG. 6 is another perspective view of the multi-function buckle.

### BEST MODE FOR CARRYING OUT THE INVENTION

The detailed description set forth below in connection with the appended drawings is intended as a description of presently-preferred embodiments of the invention and is not intended. to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Referring to the figures, the multi-function buckle 100 comprises a whistle segment 102 and a clip segment 104 to provide a connector having a number of features. Preferably, those features include a buckle, a whistle, a flint and striker, and/or a light-emitting device. Therefore, the multi-function buckle 100 functions as a fastening mechanism, a noise-maker, a fire-starter, and/or an illuminator.

The whistle segment 102 comprises the whistle housing 106 having a first end 107 and a second end 109 opposite the first end 107 and a whistle 103 therebetween. The first end 107 comprises a channel 111 configured to receive a portion of the clip segment 104, thereby defining a female part of the buckle. The second end 109 comprises a first buckle end bar 108 that defines an opening 113 for connecting the whistle segment 102 to a strap, such as a belt or cord.

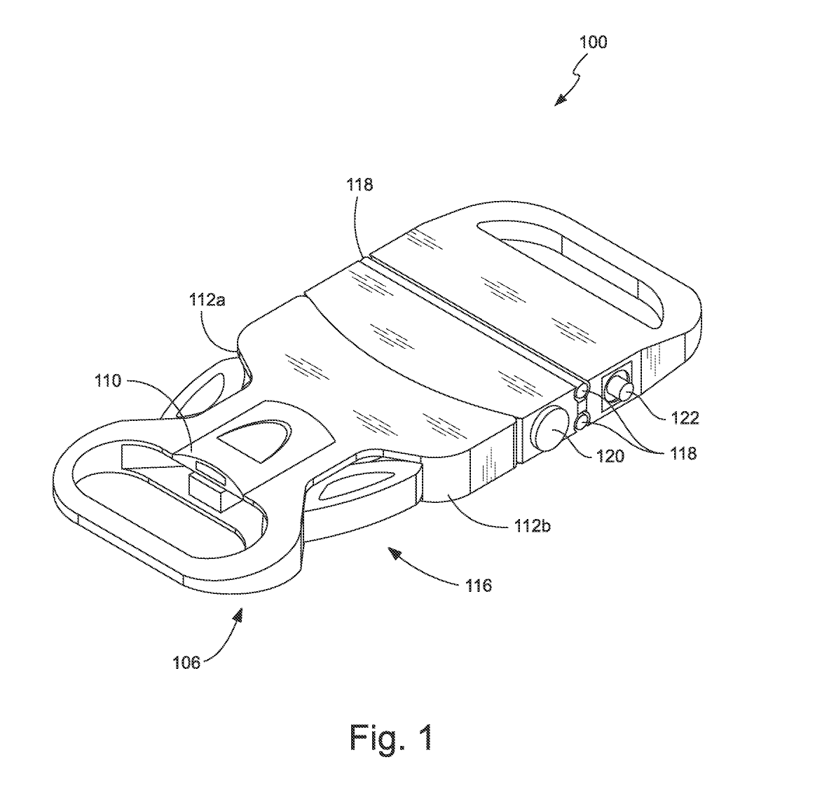

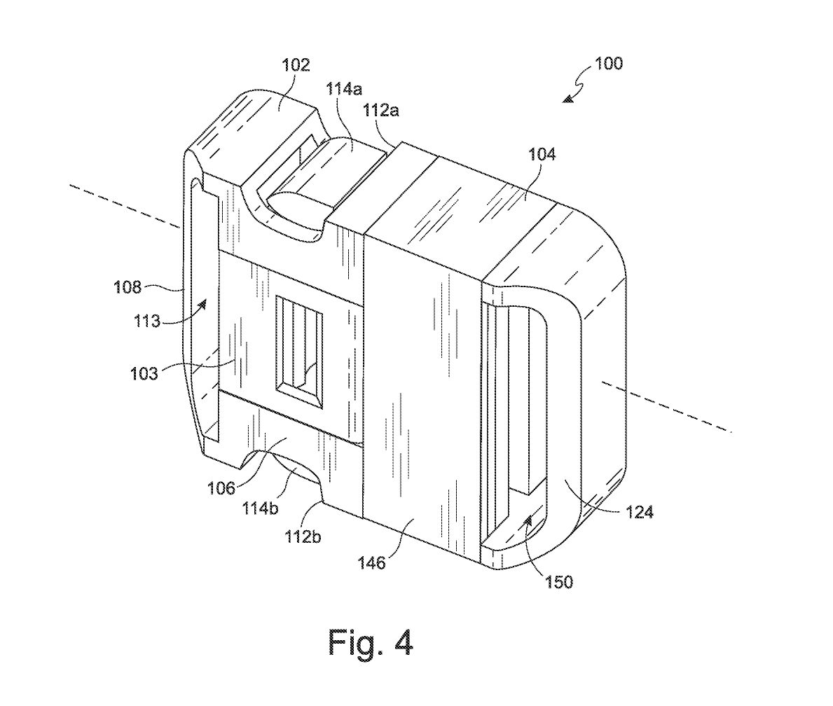

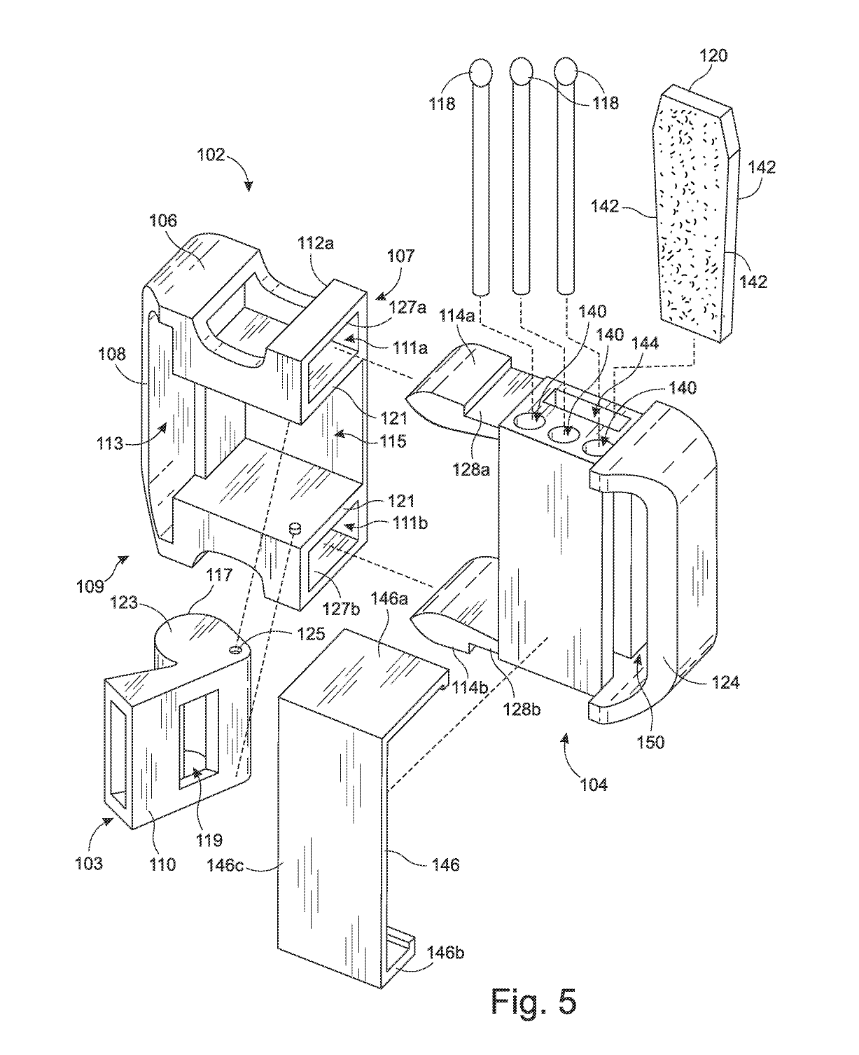

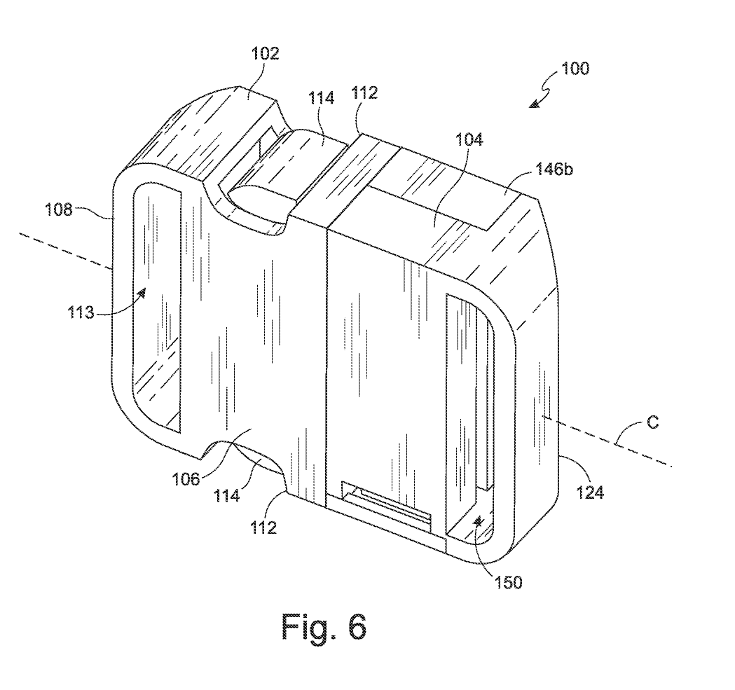

The whistle housing 106 defines a slot 115 for housing the whistle 103. The whistle 103 may be a typical whistle comprising a whistle mouthpiece 110, a body 117, and a duct 119 through which air flows to create a whistle noise. During use, the user blows into the whistle mouthpiece 110, which causes the whistle 103 to emit a whistle noise through the duct 119. In a version of the invention, the whistle 103, or a portion of it, may be pivotally connected to the whistle housing 106. For example, as shown in FIGS. 3 and 5, the body 117 of the whistle 103 may be pivotally attached to the inner walls 121 of the whistle housing 106. This allows the whistle 103 to adopt a stowed configuration as shown in FIGS. 1 and 4, and a deployed configuration as shown in FIGS. 3 and 5. In the stowed configuration, the whistle 103 inconspicuously blends in with the whistle housing 106. In the deployed configuration, the whistle mouthpiece 110 projects away from the whistle 103 housing 106, which allows the user easier access to the whistle mouthpiece 110 for activating the whistle 103. In some embodiments, the outer walls 123 of the whistle body 117 may comprise a depression 125, such as a dimple, a hole, and the like. The inner walls 121a, 121b of the whistle housing 106 may comprise corresponding pegs 129 that are received by the depression 125 to secure the whistle 103 in place in a rotatable manner. In some embodiments, the whistle 103 may be completely removable from the whistle housing 106 either by over rotation of the whistle 103, or by pulling on the whistle mouthpiece 110 with sufficient force to release the body 117 from the pegs 129. The pegs 129 and depression 125 can be reversed so that the pegs 129 are on the whistle 103 and the depression 125 are on the whistle housing 106.

The first buckle end bar 108 is shaped and dimensioned to allow a strap, such as a belt or cord, to be connected to the whistle segment 102. Therefore, in some embodiments, the first buckle end bar 108 with the whistle housing 106 defines an opening 113 through which a strap can be inserted. For example the strap may be a sternum strap on a backpack.

Preferably, the whistle segment 102 further comprises a pair of catches 112a, 112b adjacent to the channels 111a, 111b. The catches 112a, 112b correspond to the pair of hooks 114a, 114b discussed below so as to connect with the clip segment 104.

The clip segment 104 preferably comprises a side release mechanism 116, a flint 118, and a striker 120. In some embodiments, the clip segment 104 may further comprise a light emitting device 122. Some embodiments may further comprise a second buckle end bar 124.

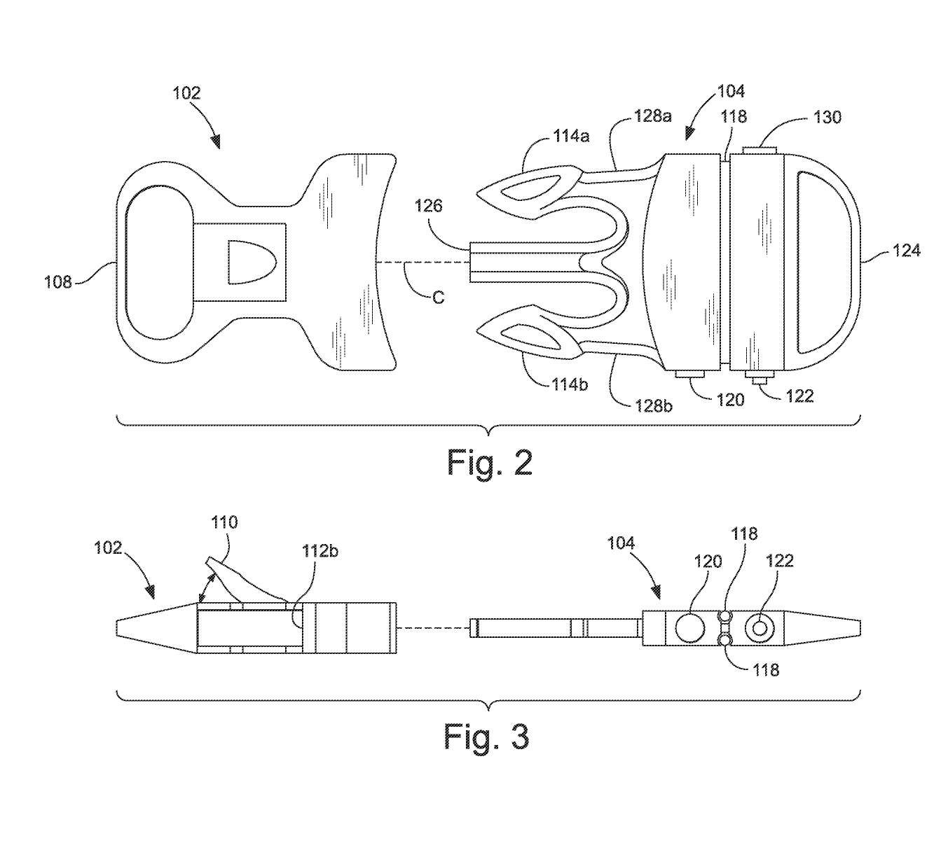

The side release mechanism 116 preferably has a pair of hooks 114a, 114b. In some embodiments, the side release mechanism 116 comprises a center guide 126 as shown in FIG. 2. In the preferred version, each of the hooks 114a, 114b is connected to the remainder of the clip segment 104 by way of spring arms 128a, 128b. The spring arms 128a, 128b allows the hooks 114a, 114b to deflect toward and away from a centerline C on the center guide 126 of the clip segment 104. In embodiments with the center guide 126, the center guide 126 may interact with the interior of the whistle segment 102 to guide and facilitate the connection between the whistle segment 102 and the clip segment 104. In a version of the invention, the center guide 126 may also interact with the whistle housing 106 to form the whistle noise when the user blows into the whistle mouthpiece 110. For example, the body 117 of the whistle 103 may comprise an additional hole through which air blown by the user through the mouthpiece 110 can exist interact with the center guide 126 to alter the sound of the whistle 103. In some embodiments, the center guide 126 may be hollow with an opening at its free end so that the air blown into the whistle can traverse through the center guide 126 to alter the sound of the whistle noise. In some embodiments, the center guide 126 may be a whistle having an opening at its free end and a duct 119 at the opposite end. In such an embodiment, the moveable whistle 103 may not be necessary.

The hooks 114a, 114b, the spring arms 128a, 128b, and, optionally, the center guide 126 comprise the male part of the buckle. In use, as the user pushes the clip segment 104 into the whistle segment 102 to join the buckle, each hook 114a, 114b is received into its respective channel 111 and contacts an interior surface 127a, 127b of the whistle segment 102. That contact causes each hook 114a, 114b to deflect toward the centerline C of the clip segment 104. As the user continues to push the clip segment 104 into the whistle segment 102, each hook 114a, 114b confronts one of the catches 112a, 112b. As it does, each hook 114a, 114b deflects away from the centerline C of the clip segment 104, thus locking the hooks 114a, 114b within their respective catch 112a, 112b, as shown in FIGS. 1 and 4. To disconnect the whistle segment 102 from the clip segment 104, the user squeezes the two hooks 114a, 114b together, which releases them from the catches 112a, 112b and allows the clip segment 104 to be withdrawn from the whistle segment 102.

The flint 118 is preferably ferrocerium, which is the material commonly used in the sparking mechanism of disposable cigarette lighters. Other material can be used that generates sparks when scraped against a striker. The flint 118 is preferably in the shape of an elongated cylinder; however, other shapes can be used. The clip segment 104 defines a flint slot 140 into which the flint 118 can be inserted and stored. Preferably, the flint slot 140 is oriented transversely across the clip segment 104 extending substantially the width of the clip segment 104 from one spring arm 1128a to the second spring arm 128b. Preferably, the buckle comprises a plurality of flints 118 and a plurality of flint slots 140 to receive each flint 118.

A spark is produced by friction as the flint 118 is scraped by the striker 120 or vice versa. In some embodiments, the striker 120 is cylindrical and made from steel. In other embodiments, the striker 120 may be flat. The striker 120 includes at least one sharp edge 142 for scraping the flint 118 abruptly to cause sparks. Preferably, the striker 120 has a plurality of sharp edges 142. In some versions, the striker 120 is knurled, like the spark wheel of a cigarette lighter. In some embodiments the striker 120 has a rough surface. In a version of the invention, the striker 120 is removable from the remainder of the clip segment 104. In this way, the striker 120 can be scraped against the flint 118 to produce a spark. The clip segment 104 may comprise a striker slot 144 to receive and store the striker 120. Preferably, the striker slot 144 is oriented transversely across the clip segment 104 extending substantially the width of the clip segment 104 from one spring arm 128a to the second spring arm 128b.

In another version, the striker 120 is not removable. Instead, the flint 118 is removable from the remainder of the clip segment 104. In this way, the flint 118 can be scraped against the striker 120 to produce a spark. In yet another version, the striker 120 can be turned about its cylindrical axis, and the flint 118 is positioned in the clip segment 104 to be in contact with the striker 120. In this way, the user may spin the striker 120, which is in contact with the flint 118, to produce sparks without the need to remove the striker 120 or the flint 118 from the remainder of the clip segment 104. In some embodiments, both the striker 120 and the flint 118 are removeable.

In some embodiments, a cap 146 may be provided to cover the flint 118 and the striker 120. In the preferred embodiment, the cap 146 may be a U-shaped clip-on type cap characterized by a first leg 146a, a second leg 146b opposite the first leg 146a, and a base 146c therebetween connecting the first leg 146a to the second leg 146b. In some embodiments, the cap 146 may show bilateral symmetry. In some embodiments, one leg 146a may be longer than the second leg 146b. For example, the first leg 146a may extend the full thickness of the clip segment 104, while the second leg 146b extends approximately half the thickness of the clip segment 104. This permits a quick and easy removal of the cap 146 to expose the flint 118 and striker 120. In some embodiments, the cap 146 may be lined with a rubber gasket to protect the flint 118 and striker 120 from moisture or wetness.

When the cap 146 is removed, at least portions of the flint 118 and the striker 120 may be exposed. The exposure may be sufficient to allow the user to remove the flint 118 or the striker 120 from the clip segment 104. In some embodiments, the exposure may be sufficient to allow one of the flint 118 or the striker 120 to be removed while the other remains in the clip segment 104, but still exposed. If the flint 118 has been removed, then the user can scrape the flint 118 across the exposed portion of the striker 120 without having to remove the striker 120 from the clip segment 104. Conversely, if the striker 120 has been removed, there may be sufficient exposure of the flint 118 so that the striker 120 can be scraped against the flint 118 while the flint 118 is still in the clip segment 104.

The light-emitting device 122 is an electronically controlled device that emits light when electrically energized. Preferably, the light-emitting device 122 is a light-emitting diode (LED). Additionally, the light-emitting device 122 is preferably positioned on the clip segment 104 such that, when emitting light, the light-emitting device 122 will illuminate an area near the flint 118 or striker 120. In this way, the user can illuminate the user's kindling or other flammable materials, which during use are located near the striker 120 or flint 118 to catch sparks from the flint 118. The light emitting device 122 can also be placed anywhere else on the buckle, including the whistle segment 102.

The light-emitting device 122 can emit light of any color, although white light and red light are preferred. White light is preferred because it allows the user to view objects near the light-emitting device 122 in true color. Red light is preferred because it does not impair the user's night vision. Preferably, the light-emitting device 122 includes an on/off switch 130 accessible from the outside of the clip segment 104. in the preferred embodiment, the light-emitting device 122 is powered by a battery contained within the clip segment 104.

The second buckle end bar 124 is shaped and dimensioned to allow a strap, including a belt or cord, to be connected to the clip segment 104. For example the strap may be a sternum strap on a backpack.

Except as noted elsewhere, the whistle segment 102 and the clip segment 104 preferably are made from a durable, non-brittle plastic, such as high-impact polystyrene. This material has an acceptable strength-to-weight ratio, and it permits the spring arms 128 to function resiliently as noted above. Other rigid material can be used, such as metal, wood, and the like.

in this way, the disclosed device provides a connector having a number of functions associated with a buckle, a whistle, a flint and striker, and/or a light-emitting device.

While the present invention has been described with regards to particular embodiments, it is recognized that additional variations of the present invention may be devised without departing from the inventive concept.

What is claimed is:

1. A multi-function buckle, comprising:
a) a whistle segment, comprising:
(i) a whistle housing having a first end and a second end, the first end defining a channel,
(ii) a first buckle end bar at the second of the whistle housing, the first buckle end bar defining a first opening for connecting the whistle segment to a first end of a strap,
(iii) a whistle operatively connected to the whistle housing to emit a whistle noise, wherein the whistle is pivotable outwardly away from the whistle housing, and
(iv) a pair of catches on opposite sides of the whistle housing; and
b) a clip segment, comprising:
(i) a pair of opposing spring arms, each spring arm terminating with a hook, the hooks configured to engage with the pair of catches via the channel,
(ii) a flint in the shape of an elongated cylinder, wherein the flint is removable from the clip segment,
(iii) a first slot to receive the flint,
(iv) a striker made of steel for striking or scraping the flint, wherein the striker is removable from the clip segment,
(v) a second slot to receive the striker, and
(vi) a second buckle end bar opposite the spring arms, the second buckle end bar defining a second opening for connecting the clip segment to a second end of the strap.

2. The multi-function buckle of claim 1, wherein the clip segment further comprises a center guide in between the pair of opposing spring arms and projecting along a centerline of the clip segment to guide and facilitate a connection between the whistle segment and the dip segment.

3. The multi-function buckle of claim 2, wherein the center guide interacts with the whistle housing to form the whistle noise when the user blows into the whistle.

4. The multi-function buckle of claim I, further comprising a light-emitting device.

5. The multi-function buckle of claim 4, wherein the light-emitting device is adjacent to the flint and the striker and configured to illuminate an area near the flint and the striker.

6. The multi-function buckle of claim 1, further comprising a cap to cover the flint and the striker.

7. The multi-function buckle of claim 1, wherein the whistle is removable from the whistle housing.

8. A multi-function buckle, comprising:
a) a whistle segment, comprising:
(i) a whistle housing having a first end and a second end, the first end defining at least one channel,
(ii) a whistle operatively connected to the whistle housing, and
(iii) a pair of catches on opposite sides of the whistle housing; and
b) a clip segment, comprising:
(i) a pair hooks configured to engage with the pair of catches via the at least one channel,
(ii) a flint removably connected to the clip segment,
(iii) a first slot to receive the flint,
(iv) a striker removably connected to the clip segment, and
(v) a second slot to receive the striker.

9. The multi-function buckle of claim 8, wherein the whistle is pivotable outwardly away from the whistle housing.

10. The multi-function buckle of claim 9, wherein the whistle is removable from the whistle housing.

11. The multi-function buckle of claim 8, further comprising a first buckle end bar at the second of the whistle housing, the first buckle end bar defining a first opening for connecting the whistle segment to a first end of a strap.

12. The multi-function buckle of claim 11 further comprising a second buckle end bar opposite the spring arms, the second buckle end bar defining a second opening for connecting the clip segment to a second end of the strap.

13. The multi-function buckle of claim 8, further comprising a cap to cover the flint and the striker.

14. A multi-function buckle, comprising:
a) a whistle segment, comprising:
(i) a whistle housing having a first end and a second end,
(ii) a whistle operatively connected to the whistle housing, the whistle configure to emit a whistle noise, and
(iii) a pair of catches on opposite sides of the whistle housing; and
b) a clip segment, comprising:
(i) a pair of opposing spring arms, each spring arm terminating with a hook, the hooks configured to engage with the pair of catches,
(ii) a flint connected to the clip segment, and
(iii) a striker connected to the clip segment.

15. The multi-function buckle of claim 14, wherein the whistle is movably mounted in the whistle housing to adopt a stowed configuration and a deployed configuration.

16. The multi-function buckle of claim 14, further comprising:
a) a first buckle end bar at the second of the whistle housing, the first buckle end bar defining a first opening for connecting the whistle segment to a first end of a strap; and
b) a second buckle end bar on the clip segment opposite the spring arms, the second buckle end bar defining a second opening fur connecting the clip segment to a second end of the strap.

17. The multi-function buckle of claim 14, wherein the clip segment further comprises a center guide in between the pair of opposing spring arms and projecting along a centerline of the clip segment to guide and facilitate a connection between the whistle segment and the clip segment, wherein the center guide interacts with the whistle housing to form the whistle noise when the user blows into the whistle.

18. The multi-function buckle of claim 14, further comprising a light-emitting device.

19. The multi-function buckle of claim 18, wherein the light-emitting device is adjacent to the flint and the striker and configured to illuminate an area near the flint and the striker.
